(19) United States
(12) Patent Application Publication
(10) Pub. No.: US 2008/0079207 A1
(43) Pub. Date: Apr. 3, 2008

(54) METHODS AND APPARATUS FOR A LEVER CONTROL

(75) Inventors: Jim Pilon, Portland, OR (US); John Herrick, Aloha, OR (US); Tom Dunlap, West Linn, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Williams Controils Industries, Inc., Portland, OR (US)

(21) Appl. No.: 11/536,205

(22) Filed: Sep. 28, 2006

(51) Int. Cl. F16F 1/18

(52) U.S. Cl. 267/158

(57) ABSTRACT

Embodiments of the present invention provide a rotary based hand control that provides hysteresis to an operator. Other embodiments may be described and claimed.

### TECHNICAL FIELD

Embodiments of the present invention relate to the field of hand controls for various apparatus, more specifically, to hand controls that include hysteresis.

### BACKGROUND

General hand controls for various types of machinery often require some type of drag or hysteresis. The purpose of such drag is to give the operator some feed back (kinesthetics) and to help insure that the control position remains constant despite being influenced by external factors, such as vibration or light contact. In other representative designs of such devices, compression packs (disks and coil springs) are typically employed to provide a clamping force on an axis of rotation for the control. However, such devices generally require adjustment and setting at the time of assembly and consist of multiple parts, such as, for example, washers and rub plates under compression that are clamped to a handle of the control.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a perspective view of a hand control in accordance with various embodiments of the present invention;

FIG. 2 is a side elevation view of a hand control in accordance with various embodiments of the present invention; and

FIG. 3 is an exploded view of a hand control in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

Embodiments of the present invention provide a rotary based hand control that provides hysteresis to an operator.

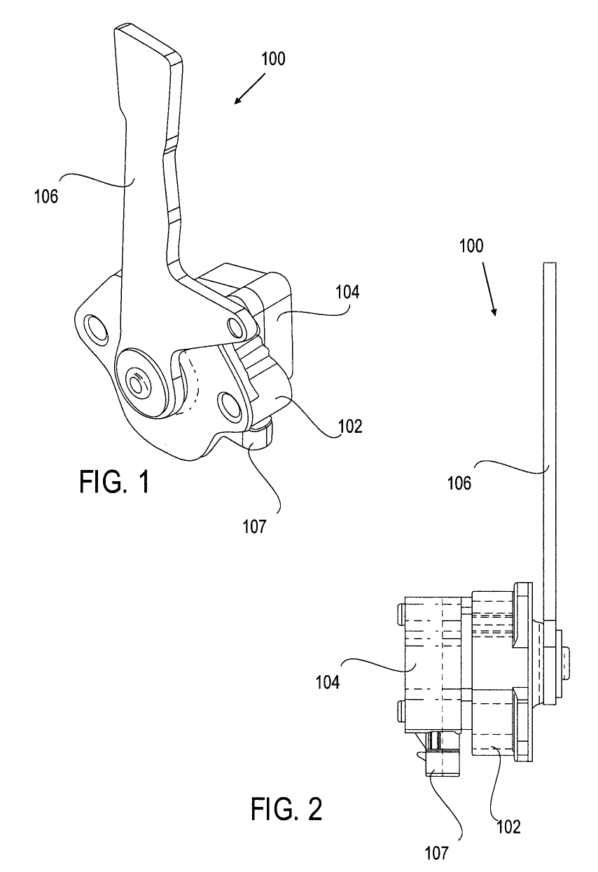

Referring to FIGS. 1 and 2, a hand control 100 in accordance with various embodiments of the present invention is illustrated. The hand control may include a body 102, a position sensor 104 and a lever 106 arranged as shown. The sensor 104 includes an appropriate electrical coupling 107 known in the art for coupling the hand control to a control system (not shown). For example, sensor 104 may be a contact or non-contact type position sensor adapted to sense the lever position and generate a control based signal.

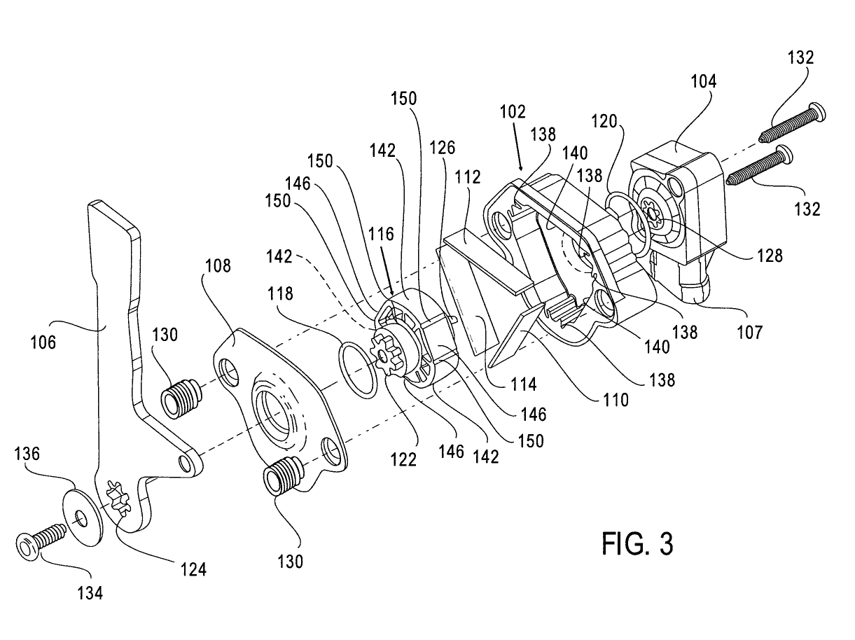

In one embodiment, as illustrated in FIG. 3, body 102 may include a cover plate 108 coupled thereto. Additionally, three substantially flat spring elements 110, 112 and 114 may be arranged within the body 102. In one embodiment, the spring elements may be arranged in a substantially triangular shape, for example, as an equilateral triangle. In other embodiments, other spring element configurations may be used in order to vary the hysteresis response.

In one embodiment, a rotor 116 may be positioned adjacent to the spring elements and adapted to selectively engage the spring elements. An O-ring 118 may be provided between the rotor 116 and the cover plate 108. Similarly, an O-ring 120 may be placed between the sensor 104 and the body 102.

In one embodiment, the rotor may be coupled to the lever via a cooperative mating structure, such that manipulation of the lever causes manipulation of the rotor 116. As an example, in FIG. 3, the cooperative mating structure may be a star-shaped gear 122 on the rotor that cooperates with a star shape 124 defined within the lever. Additionally, the rotor may be coupled to the sensor 104 via a cooperative mating structure. For example, the cooperative mating structure may also be a star-shaped arrangement 126 and 128. It can be appreciated that a number of mating structures may be used to couple the rotor 116 to the lever and/or sensor.

The cover plate 108 may be coupled to the body 102 via suitable means such as, for example, retainers 130. Additionally, the sensor may be coupled to the body via suitable means such as, for example, two screws 132. Finally, the lever may be coupled to the rotor via a suitable coupling device such as, for example, a screw 134. In the exemplary embodiment illustrated, a washer 136 may be placed between the lever and the screw.

In one embodiment, as illustrated in FIG. 3, body 102 may include receptors 138 in the form of slots that may be adapted to receive the ends of the spring elements 110, 112 and 114, and thereby retain the spring elements in a desired position such that they may be deformed or “flex” with respect to the body during use of the hand control. In one embodiment, the body may be configured to have a clearance between the body and each spring element, such as by providing indentations 140, to allow for such flex. In one embodiment, the slots engage and hold the ends of the spring elements while the clearance provided between the body and the main portions of the spring elements allows for their flexation.

In one embodiment, the rotor may include three protruded portions 142 (only two are shown in FIG. 3) separated by three recessed and/or substantially flat portions 146. The protruded portions 142 may be configured to engage the main portions of the spring elements when the rotor is in a home position. During operation of the hand control, rotation of the rotor causes the rounded portions to move against the spring elements to thereby deform the spring elements. This engagement may provide tactile “feed back” to the operator as the lever is being moved.

In one embodiment, the engagement between the spring elements and the protruded portions of the rotor may cause enough holding resistance to resist further advancement or reverse movement of the lever, even in light of external influences, such as vibration, inadvertent contact, and the like.

In one embodiment, the protruded portion may be non-symmetrically configured such that as the lever further causes rotational movement of the edge portions 150 of the rotor, the engagement with the spring elements may get progressively greater and render movement of the lever more difficult (i.e. the resistance increases). Thus, resistance to movement is provided through the lever to the operator. In other embodiments the spring configuration may be altered to achieve a similar result.

Thus, in operation, the lever may be used to control at least one parameter of a device, such as, for example, an engine. In one embodiment, by moving the lever 106, the rotor 116 may be caused to move or rotate relative to the spring elements 110, 112 and 114. The engagement between the spring elements 110, 112 and 114 and the protruded portions 142 may cause the rotor to hold a desired position, until the lever is further manipulated by an operator. Such movement may also cause the sensor to sense the amount of rotation of the rotor due to the cooperative mating structure coupling it to the rotor. The sensor then provides this information to a control system. The control system uses this to control at least one parameter. As an example, this information may be used to control the speed of an engine. Further, the lever may be any one of a variety of input controls, including, but not limited to, hand controls, foot controls and the like.

As noted, the flexing of the spring elements helps generate feedback felt by an operator that is applying force to the lever. This also helps to ensure a constant application of force to the lever despite external vibrations and other factors that may be occurring.

Those skilled in the art will understand that only one or two spring elements may be used if desired and that more than three spring elements may be used if desired. Though the illustrated embodiment shows a rotor having an equal number of spring elements and protruded portions, this need not be the case. In various embodiments, the number of flat or recessed portions, the number of protruded portions, and/or the number of spring elements may all be varied in order to achieve the desired feed back and hold characteristics. Additionally, the rotor may be configured with flexible sides and the body may be configured with the protrusions, thereby reversing the spring and protrusion arrangement.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A control apparatus comprising:
a housing;
one or more spring elements disposed within the housing such that at least a portion of the spring element may flex;
a rotor located proximal to the one or more spring elements, the rotor having one or more protruded portions adapted to engage the one or more spring elements; and
a lever coupled to the rotor and adapted to move the rotor relative to the one or more spring elements to cause the one or more spring elements to flex.

2. The control apparatus of claim 1, wherein the housing includes one or more receptors adapted to hold a corresponding one or more spring elements.

3. The apparatus of claim 2, comprising three receptors and three substantially flat spring elements, a first spring element being located within a first of three receptors, a second spring element being located within a second of the three receptors, and a third spring element being located within a third of the three receptors.

4. The apparatus of claim 3, wherein the three spring elements are arranged in a substantially triangular shape.

5. The apparatus of claim 4, wherein the spring elements are arranged as an equilateral triangle.

6. The apparatus of claim 4, wherein the receptors are configured as slots for receiving the ends of the spring elements.

7. The apparatus of claim 4, wherein the rotor comprises three protruded portions, each protruded portion engaging one of the spring elements when the pivot is in a home position.

8. The apparatus of claim 7, wherein the rotor further comprises three substantially flat portions interposed between the three protruded portions.

9. The apparatus of claim 1, further comprising a sensor coupled to the rotor that senses movement of the rotor to control operation of a device.

10. A method comprising:
engaging a pivot with substantially flat spring elements located within a housing;
moving the pivot relative to the spring elements to deform the spring elements;
sensing movement of the pivot with a sensor operatively coupled to the pivot; and
translating sensed movement of the pivot to control at least one parameter of an apparatus.

11. The method of claim 10, wherein moving the pivot comprises moving a lever operatively coupled to the pivot.

12. A hand control for controlling at least one parameter of an engine's operation, the control comprising:
a housing including three retainer portions defined therein;
three substantially flat spring elements correspondingly arranged within the three retainer portions;
a pivot located adjacent to and engaging the three spring elements;
a lever operatively coupled to the rotor to move the rotor relative to the spring elements to deform the three spring elements; and
a sensor operatively coupled to the pivot to sense movement of the rotor to control the at least one parameter.

13. The hand control of claim 12, wherein the three spring elements are arranged in a substantially triangular shape.

14. The hand control of claim 13, wherein the spring elements are arranged as an equilateral triangle.

15. The hand control of claim 12, wherein the pivot comprises three rounded portions, each rounded portion engaging one of the spring elements when the pivot is in a home position.

16. The hand control of claim 15, wherein the pivot further comprises three substantially flat portions interposed between the three rounded portions.

17. The hand control of claim 11, wherein the at least one parameter is speed of the engine.
